(19) United States
(12) Patent Application Publication
(10) Pub. No.: US 2024/0146483 A1
(43) Pub. Date: May 2, 2024

(54) GROUP COMMON CONFIGURED GRANT RESOURCE CONFIGURATION

(71) Applicant: Lenovo (Singapore) Pte. Ltd., New Tech Park (SG)

(72) Inventors: Karthikeyan Ganesan, Kronberg im Taunus (DE); Joachim Löhr, Wiesbaden (DE); Prateek Basu Mallick, Dreieich (DE); Ravi Kuchibhotla, Chicago, IL (US)

(21) Appl. No.: 18/549,146

(22) PCT Filed: Feb. 28, 2022
(86) PCT No.: PCT/IB2022/051759

§ 371 Date: Sep. 5, 2023

Related U.S. Application Data
(60) Provisional application No. 63/157,529, filed on Mar. 5, 2021.

(51) Int. Cl. H04L 5/00; H04W 72/231; H04W 72/232

(52) U.S. Cl. CPC H04L 5/0053; H04W 72/231; H04W 72/232

(57) ABSTRACT

Various aspects of the present disclosure relate to group common configured grant resource configuration. One apparatus includes at least one memory and at least one processor that is configured to receives a group common configured grant (“CG”) configuration for a group common CG resource, the group common CG configuration for a plurality of UE devices in a group, determine, based on the group common CG configuration, a UE-specific CG resource configuration for the group common CG resource, the UE-specific CG resource configuration comprising one or more group common CG parameters and one or more UE-specific parameters for the group common CG resource, and perform data communications using the group common CG resource according to the group common CG parameters and the UE-specific CG parameters.

### CROSS-REFERENCE TO RELATED APPLICATIONS

This application claims the benefit of U.S. Provisional Patent Application No. 63/157,529, entitled “GROUP COMMON CYCLIC CONFIGURED GRANT ENHANCEMENT FOR IIOT” and filed on Mar. 5, 2021, for Karthikeyan Ganesan et al., which is incorporated herein by reference.

### FIELD

The subject matter disclosed herein relates generally to wireless communications and more particularly relates to group common configured grant resource configuration.

### BACKGROUND

In the sidelink (“SL”) evolution, supporting ultra-reliable low latency communication (“URLLC”) features like mini-slot type transmissions may be beneficial for industrial internet of things (“IIoT”)-type applications requiring lower latency and higher reliability. In the current sidelink release, the configured grant resources are only known between a base station, e.g., a gNB a transmitting (“Tx”) user equipment (“UE”), while a receiving (“Rx”) UE is not aware of the configured grant resource signaled between the gNB and the Tx UE. Also, the gNB may not identify UEs in the sidelink by mapping a source ID or a destination ID with the cell-radio network temporary identifiers (“C-RNTIs”). In IIoT/URLLC, periodic cyclic traffic may be one of the key aspects, which means there is a reply provided from the Rx UE at a predefined offset after the transmission from the Tx UE. Such an aspect may be exploited by providing a cyclic configured grant to UEs.

### BRIEF SUMMARY

Disclosed are procedures for group common configured grant resource configuration. The procedures may be implemented by apparatus, systems, methods, or computer program products.

In one embodiment, a first apparatus includes a transceiver that receives, from a network, a group common configured grant (“CG”) configuration for a group common CG resource, the group common CG configuration for a plurality of UE devices in a group. In one embodiment, the first apparatus includes a processor that determines, from the group common CG configuration, a UE-specific CG resource configuration for the group common CG resource, the UE-specific CG resource configuration comprising one or more group common CG parameters and one or more UE-specific parameters for the group common CG resource. In one embodiment, the transceiver transmits and receives data using the group common CG resource according to the group common CG parameters and the UE-specific CG parameters.

In one embodiment, a first method receives, from a network, a group common configured grant (“CG”) configuration for a group common CG resource, the group common CG configuration for a plurality of UE devices in a group. In one embodiment, the first method determines, from the group common CG configuration, a UE-specific CG resource configuration for the group common CG resource, the UE-specific CG resource configuration comprising one or more group common CG parameters and one or more UE-specific parameters for the group common CG resource. In one embodiment, the first method transmits and receives data using the group common CG resource according to the group common CG parameters and the UE-specific CG parameters.

In one embodiment, a second apparatus includes a processor that determines one or more group common configured grant (“CG”) parameters and one or more user equipment (“UE”)-specific parameters for a group common CG resource. In one embodiment, the second apparatus includes a transceiver that transmits, to a plurality of UE devices, a group common CG configuration for the group common CG resource, the group common CG configuration comprising the group common CG parameters and the UE-specific parameters. In one embodiment, the transceiver transmits and receives data to/from the plurality of UE devices using the group common CG resource according to the group common CG parameters and the UE-specific CG parameters.

In one embodiment, a second method determines one or more group common configured grant (“CG”) parameters and one or more user equipment (“UE”)-specific parameters for a group common CG resource. In one embodiment, the second method transmits, to a plurality of UE devices, a group common CG configuration for the group common CG resource, the group common CG configuration comprising the group common CG parameters and the UE-specific parameters. In one embodiment, the second method transmits and receives data to/from the plurality of UE devices using the group common CG resource according to the group common CG parameters and the UE-specific CG parameters.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for group common configured grant resource configuration;

FIG. 2 is one embodiment of a sidelink configured grant configuration information element;

FIG. 3A is one embodiment of a configured grant configuration information element;

FIG. 3B is a continuation of the information element of FIG. 3A;

FIG. 3C is a continuation of the information element of FIGS. 3A and 3B;

FIG. 4 is a diagram illustrating one embodiment of group common cyclic configured grant with UE specific resource;

FIG. 5 is a diagram illustrating one embodiment of group common cyclic configured grant with UE specific resource repeating;

FIG. 6 is a diagram illustrating one embodiment of a configured grant that is associated with a UE belonging to a group destination;

FIG. 7 is a diagram illustrating one embodiment of a configured grant that is associated with a group destination where selection of a configured grant depends on the traffic arrival;

FIG. 8 is a block diagram illustrating one embodiment of a user equipment apparatus that may be used for group common configured grant resource configuration;

FIG. 9 is a block diagram illustrating one embodiment of a network equipment apparatus that may be used for group common configured grant resource configuration;

FIG. 10 is a block diagram illustrating one embodiment of a first method for group common configured grant resource configuration; and

FIG. 11 is a block diagram illustrating one embodiment of a second method for group common configured grant resource configuration.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for group common configured grant resource configuration. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In the sidelink evolution, supporting URLLC features like mini-slot type transmissions may be beneficial for IIoT-type applications requiring lower latency and higher reliability. In the current sidelink release, the configured grant resources are only known between a gNB and a Tx UE, while a Rx UE is not aware of the configured grant resource signaled between the gNB and the Tx UE. Also, the gNB may not identify UEs in the sidelink by mapping a source ID/destination ID with the C-RNTIs.

In IIoT/URLLC, periodic cyclic traffic is the one of the key aspects which means there is always a reply provided from the Rx UE at a predefined offset after the transmission from the Tx UE. Such an aspect can be exploited by providing cyclic configured grant to UEs. In this disclosure, the configuration for cyclic configured grant, physical sidelink feedback channel (“PSFCH”)/physical uplink control channel (“PUCCH”) resource corresponding to each UE transmission, and activation by group common downlink control information (“DCI”) is discussed.

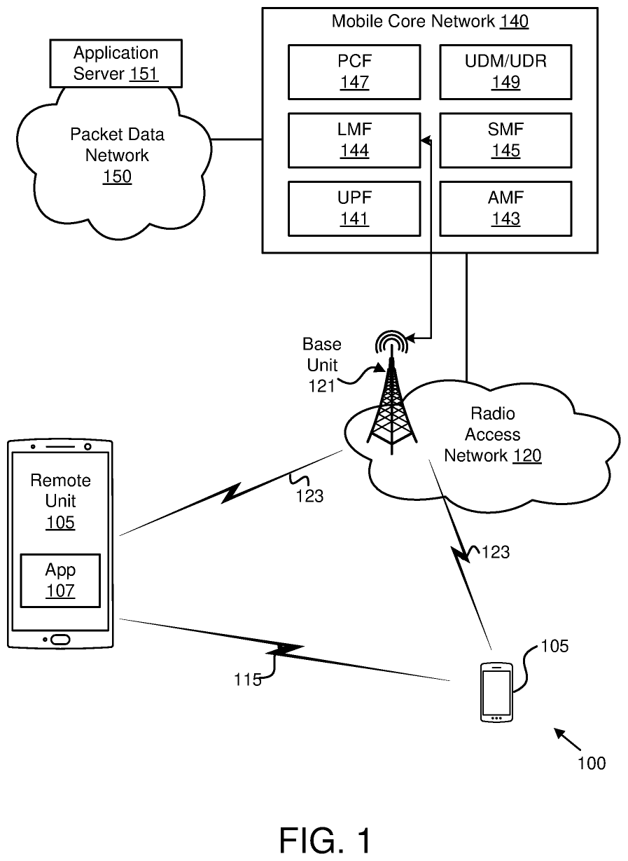

FIG. 1 depicts a wireless communication system 100 for group common configured grant resource configuration, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals. Furthermore, the UL and DL communication signals may be carried over the wireless communication links 123. Here, the RAN 120 is an intermediate network that provides the remote units 105 with access to the mobile core network 140. As described in greater detail below, the base unit(s) 121 may provide a cell operating using a first frequency range and/or a cell operating using a second frequency range.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

To establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, e.g., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, abase station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (e.g., shared) radio spectrum.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Location Management Function (“LMF”) 144, a Unified Data Management function (“UDM”) and a User Data Repository (“UDR”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (DN), in the 5G architecture. The AMF 143 is responsible for termination of NAS signaling, NAS ciphering & integrity protection, registration management, connection management, mobility management, access authentication and authorization, security context management. The SMF 145 is responsible for session management (e.g., session establishment, modification, release), remote unit (e.g., UE) IP address allocation & management, DL data notification, and traffic steering configuration of the UPF 141 for proper traffic routing.

The LMF 144 receives positioning measurements or estimates from RAN 120 and the remote unit 105 (e.g., via the AMF 143) and computes the position of the remote unit 105. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Policy Control Function (“PCF”) (which provides policy rules to CP functions), a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

In one embodiment, as used herein, a sidelink connection 115 allows remote units 105 to communicate directly with each other (e.g., device-to-device communication) using sidelink (e.g., V2X communication) signals.

While FIG. 1 depicts components of a 5G RAN and a 5G core network, the described embodiments for group common configured grant resource configuration apply to other types of communication networks and RATs, including IEEE 802.11 variants, Global System for Mobile Communications (“GSM”, e.g., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station but it is replaceable by any other radio access node, e.g., gNB, ng-eNB, eNB, Base Station (“BS”), Access Point (“AP”), etc. Further, the operations are described mainly in the context of 5G NR. However, the proposed solutions/methods are also equally applicable to other mobile communication systems supporting group common configured grant resource configuration.

As background, Table 1 below shows various features of a sidelink configured grant:

TABLE 1
Sidelink Configured Grant

| CG features | Rel.16 I-IOT (URLLC) | Rel.16 NR-U | Rel.16 Sidelink |
|---|---|---|---|
| Multiple CG | Supported | Supported | Supported |
| configurations | | | |
| HARQ process | Associated with the | Decide and reported | Calculated based on |
| number/ID | configured/indicated | by the UE in CG-UCI | equations |
| determination | first TO, calculated | | |
| | based on the equation | | |
| | defined in TS 38.321 | | |
| Management of | Not shared between | Can be shared | Not shared between |
| HARQ process | different CG | between different CG | different CG |
| number/ID among | configurations in the | configurations in the | configurations |
| multiple CG | same BWP | same BWP | |
| configurations | | | |
| RV determination | One of the three RV | Decide and reported | N.A |
| | sequence can be | by the UE in CG-UCI | |
| | configured and | | |
| | associated with TO | | |
| | {0, 0, 0, 0}; {0, 3, 0, 3}; | | |
| | {0, 2, 3, 1} | | |
| Flexible initial | If the CG is configured | Multiple consecutive | N.A |
| transmission | with | potential Tos are | |
| occasion (TO) | Configuredgrantconfig- | configured by cg- | |
| | StartingfromRV0 set to | nrofPUSCH-InSlot- | |
| | ‘off’, the initial | r16 and cg-nrofSlots- | |
| | transmission only starts | r16, can start initial | |
| | at the first TO of the K | transmission at any | |
| | repetitions; otherwise, | Tos depending on the | |
| | the initial transmission | LBT results. | |
| | TO depends on the | | |
| | configured RV | | |
| | sequence and K | | |
| | repetitions. | | |
| Repetition | PUSCH repetition Type | Similar as PUSCH | N.A |
| scheme(s) | A and PUSCH | repetition Type B | |
| | repetition Type B | without supporting | |
| | | segmentation. (no | |
| | | support of cross-slot | |
| | | resource allocation, | |
| | | and if collide with | |
| | | invalid symbol(s), | |
| | | drop the repetition) | |
| CG-Downlink | No support. If Re- | Support, If CG-DFI is | Support, PSFCH and |
| feedback | scheduling UL grant is | not received, UE | PUCCH feedback |
| information (DFI) | not received, UE | assumes NACK. | |
| | assumes ACK. | | |
| CG Re- | No support | Support and always | N.A |
| transmission timer | | configured | |
| CG transmission | Autonomous | Autonomous | N.A |
| failure | transmission. | retransmission. | |
| (MAC PDU has | For a CG, if the MAC | If the MAC PDU is | |
| been generated but | PDU is generated but | generated for a CG, | |
| fails to transmit) | the CG is de- | but LBT failure is | |
| | prioritized, the MAC | indicated by the lower | |
| | PDU can be | layer, the HARQ | |
| | autonomously | process is considered | |
| | transmitted using the | as pending. The TB | |
| | next CG occasion | can be retransmitted | |
| | associated with the | using a configured | |
| | same HARQ process | grant belonging the | |
| | ID, if no retransmission | same or different | |
| | grant is scheduled by | configured grant | |
| | the gNB. | configuration, as long | |
| | | as they have the same | |
| | | TBS. | |
| CG Retransmission | Retransmission is | Retransmission can be | Retransmission is |
| | scheduled by the gNB | scheduled by the gNB | scheduled by the |
| | with CS-RNTI. | with CS-RNTI. | gNB |
| | | Autonomous | |
| | | retransmission use | |
| | | configured grants: for | |
| | | a HARQ process, if | |
| | | configuredGrantTimer | |
| | | is running while cg- | |
| | | RetransmissionTimer | |
| | | is not running, e.g. no | |
| | | DFI received, the TB | |
| | | can be retransmitted | |
| | | using a configured | |
| | | grant belonging the | |
| | | same or different | |
| | | configured grant | |
| | | configuration, as long | |
| | | as they are with the | |
| | | same TBS. | |

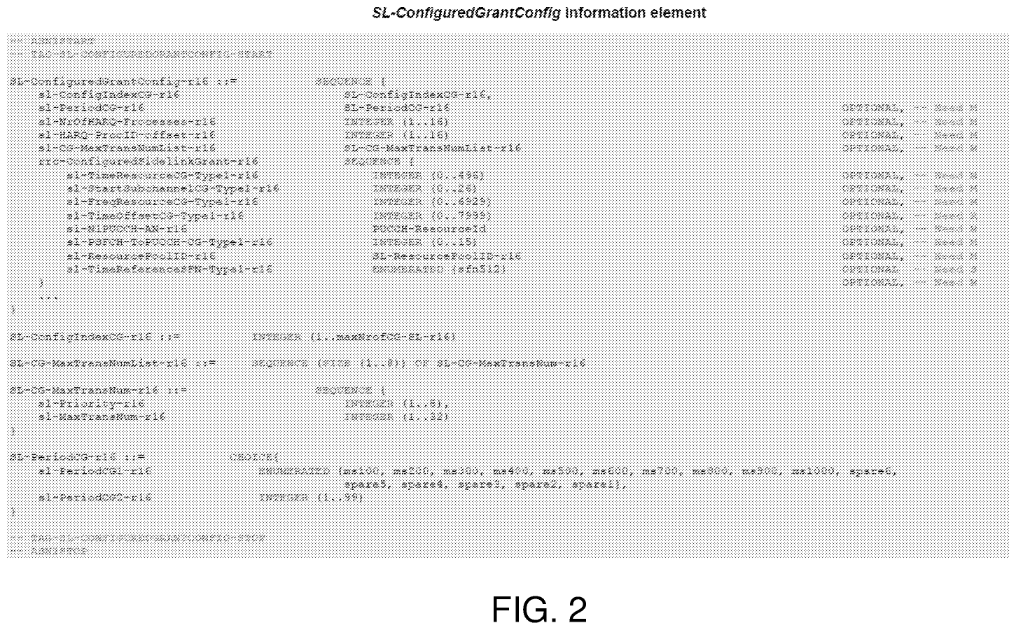

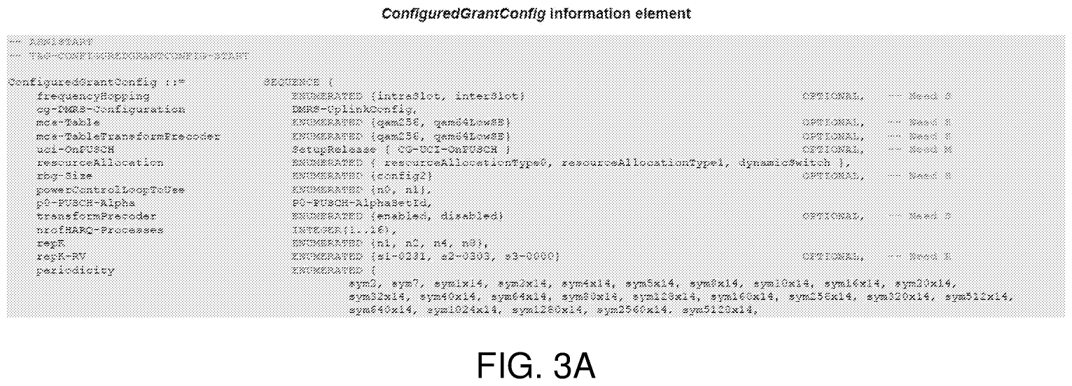

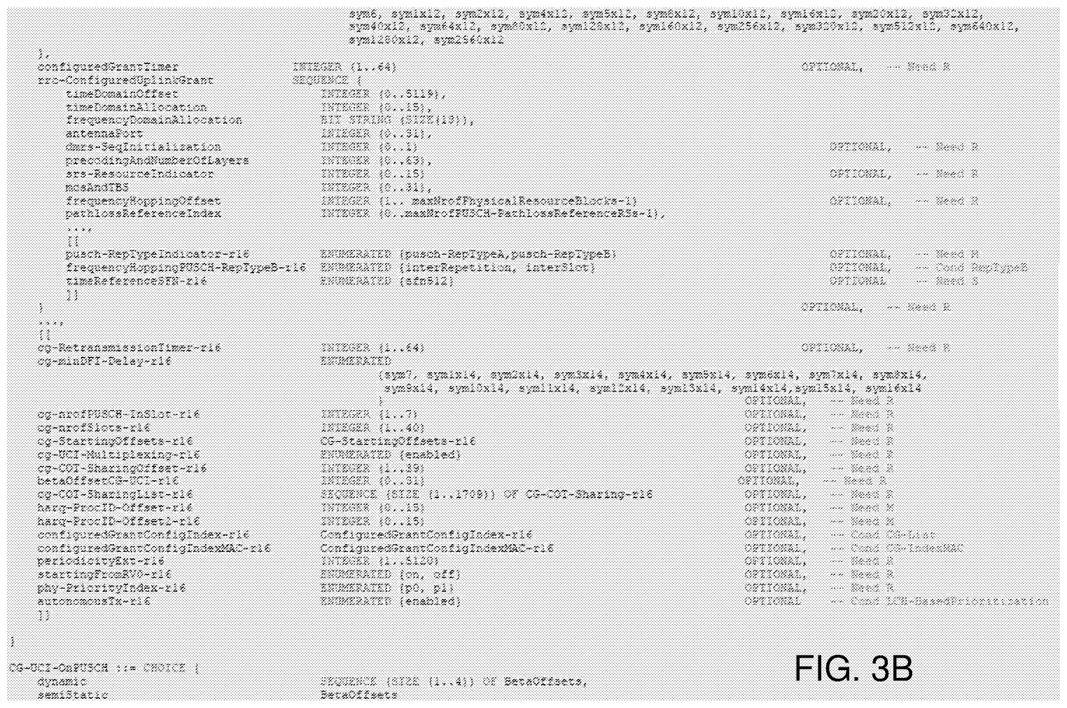

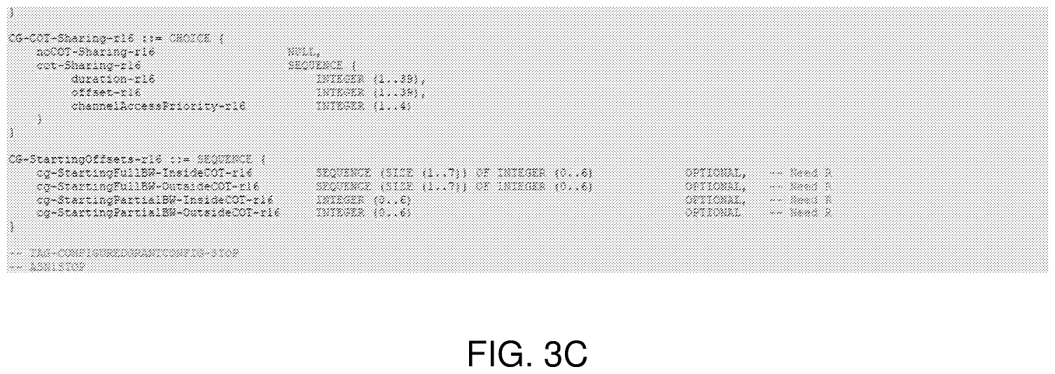

FIGS. 2 and 3A-3C illustrate a sidelink configured grant configuration information element and a configured grant configuration information element, e.g., as described in TS 38.331, which may be applicable to the subject matter disclosed herein.

In sidelink resource allocation mode 1, for physical sidelink shared channel (“PSSCH”) and physical sidelink control channel (“PSCCH”) transmission, dynamic grant, configured grant Type 1 and configured grant Type 2 are supported. The configured grant type 2 sidelink transmission is semi-persistently scheduled by a SL grant in a valid activation DCI, e.g., according to Clause 10.3 of TS 38.213.

Regarding resource allocation in the time domain, in one embodiment, the UE transmits the PSSCH in the same slot as the associated PSCCH. In one embodiment, the minimum resource allocation unit in the time domain is a slot. The UE may transmit the PSSCH in consecutive symbols within the slot, subject to the following restrictions:
i. The UE shall not transmit PSSCH in symbols that are not configured for sidelink. In one embodiment, a symbol is configured for sidelink according to higher layer parameters startSLsymbols and lengthSLsymbols, where startSLsymbols is the symbol index of the first symbol of lengthSLsymbols consecutive symbols configured for sidelink.
ii. Within the slot, a PSSCH resource allocation starts at symbol startSLsymbols+1.
iii. The UE shall not transmit PSSCH in symbols that are configured for use by PSFCH, if PSFCH is configured in this slot.
iv. The UE shall not transmit PSSCH in the last symbol configured for sidelink.
v. The UE shall not transmit PSSCH in the symbol immediately preceding the symbols that are configured for use by PSFCH, if PSFCH is configured in this slot.

In sidelink resource allocation mode 1:
i. For sidelink dynamic grant, the PSSCH transmission is scheduled by a DCI format 3_0.
ii. For sidelink configured grant type 2, the configured grant is activated by a DCI format 3_0.
iii. For sidelink dynamic grant and sidelink configured grant type 2:
   1. The “Time gap” field value m of the DCI format 30 provides an index m+1 into a slot offset table. That table is given by higher layer parameter timeGapFirstSidelinkTransmission and the table value at index m+1 will be referred to as slot offset K_{SL}.
   2. The slot of the first sidelink transmission scheduled by the DCI is the first SL slot of the corresponding resource pool that starts not earlier than T_{DL-TTA2}+K_{SL}×Tₛₗₒₜ where T_{DL} is starting time of the downlink slot carrying the corresponding DCI, T_{TA} is the timing advance value corresponding to the TAG of the serving cell on which the DCI is received and K_{SL} is the slot offset between the slot DCI and the first sidelink transmission scheduled by DCI and Tₛₗₒₜ is the SL slot duration.
iv. For sidelink configured grant type 1, the slot of the first sidelink transmission follows the higher layer configuration, e.g., according to TS 38.321.

In one embodiment, regarding resource allocation in the frequency domain, the resource allocation unit in the frequency domain is the sub-channel. The sub-channel assignment for sidelink transmission may be determined using the “frequency resource assignment” field in the associated sidelink control information (“SCI”).

In one embodiment, the lowest sub-channel for sidelink transmission is the sub-channel on which the lowest physical resource block (“PRB”) of the associated PSCCH is transmitted.

In one embodiment, if a PSSCH scheduled by a PSCCH would overlap with resources containing the PSCCH, the resources corresponding to a union of the PSCCH that scheduled the PSSCH and an associated PSCCH demodulation reference signal (“DM-RS”) are not available for the PSSCH.

In this disclosure, changes in existing Rel-16 NR physical layer and MAC are proposed due to the introduction of low latency cyclic configured grant transmission/reception.

In one embodiment, a configuration of group common type 2 configured grant resource is disclosed where each UE in the group is assigned with a starting offset for each of the CG resources based on the burst arrival time provided as part of the assistance information, number of CG resources per UE from the starting offset in a period, and periodicity of the CG resource considering cyclic traffic provided as part of the assistance information. Multiple PUCCH resources can be provided for each of the UEs to report hybrid automatic repeat request (“HARQ”) ACK or NACK at the end of its CG resource. Similarly, UE-specific HARQ process offsets could be configured.

In one embodiment, transmission and/or repetition by each UE within the CG resource is provided by starting offset and number of CG resources within a period. In one embodiment, only one new transport block (“TB”) can be transmitted by each UE in a period.

In one embodiment, the subject matter herein describes activation of the type-2 CG resource using group common DCI. In one embodiment, medium access control control element (“MAC CE”) confirmation of the activation/deactivation is disclosed.

As used herein, in one embodiment:
i. A mini-slot's starting symbol offset from the beginning of a logical SL slot is defined by S;
ii. A mini-slot's PSSCH symbol duration is defined by L consecutive symbols;
iii. A symbol offset between DCI and start of sidelink transmission is defined in terms of K_{SL};
iv. A symbol offset between PSSCH and PSFCH is defined in terms of K₁;
v. A symbol offset between PSFCH and PUCCH is defined in terms of K₂;
vi. A number of repetitions and type of repetition (Type A/Type B) are defined;
vii. Time domain allocation for the reserved resources based on the sl-MaxNumPerReserve is described;
viii. Logical SL slots are defined as the slots within a resource pool; and
ix. Logical SL symbols are defined as the symbols within a resource pool.

According to a first embodiment, a configuration of group common configured grant resources is provided to a group of UEs and then each UE in the group common CG configuration is assigned with a UE-specific CG resource configuration, which may include UE-specific parameters and group common parameters. In one embodiment, the UE-specific parameters may include:
i. A UE-specific starting time offset based on the burst arrival time provided as part of the assistance information;
ii. A number ‘N’ of CG resources assigned per UE from the starting offset in a period;
iii. UE-specific PSFCH resources; and/or
iv. UE-specific PUCCH resource.

In one embodiment, the group common CG includes a common set of parameters that are applicable for transmission for all UEs in the group. In one embodiment, the group common parameters may include:
i. A periodicity of CG resources taking into consideration cyclic traffic;
ii. A number of HARQ processes;
iii. A HARQ process offset that could be used to derive the HARQ process IDs for transmission in each UE-specific CG resource. In another implementation, HARQ process offset could be provided as a UE-specific parameter;
iv. PSFCH to PUCCH offset;
v. A PHY priority and a maximum number of times a TB can be transmitted using the resources provided by the configured grant; otherwise, a number of repetitions of a TB transmitted by each UE in its own CG resource within a period, K.
vi. A maximum number of blind retransmissions of a TB; and/or
vii. A redundancy version pattern.

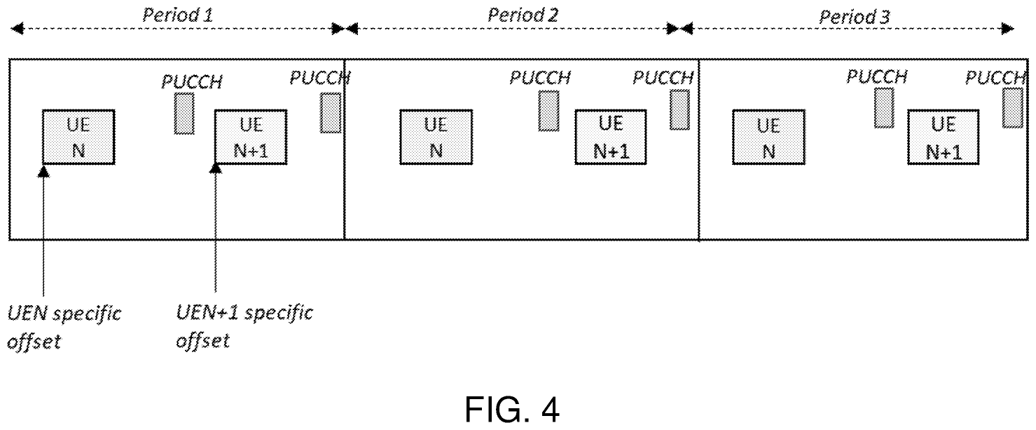

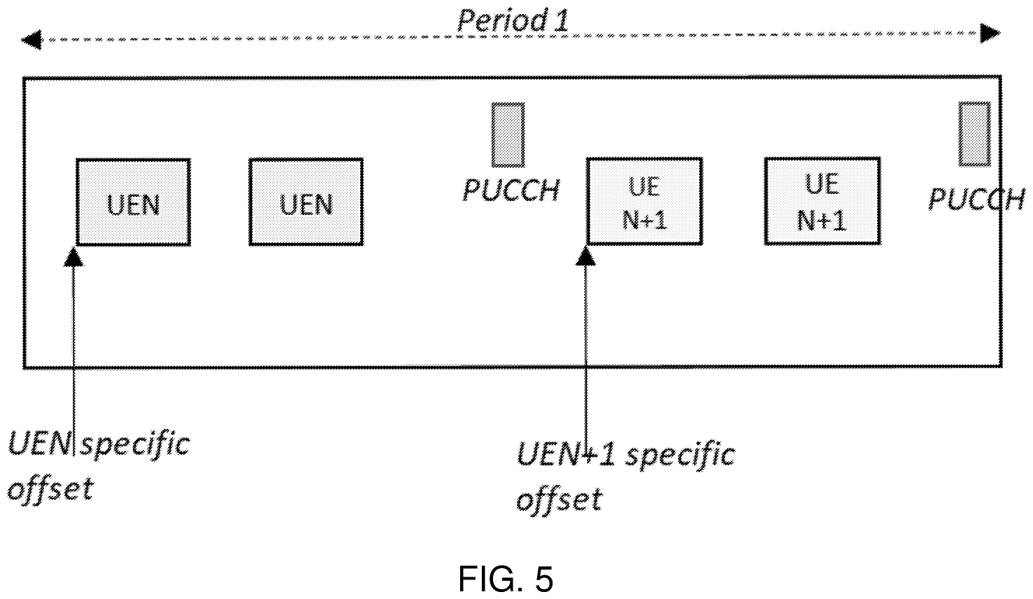

In a first implementation, each CG period contains 2, 4, 6, 8, and so on (other values not precluded) group common CG resources taking into consideration transmission and/or repetitions of all UEs in a group, while N consecutive CG resources are allocated to each UE where N=1, as shown in FIG. 4, and N=2 as shown in FIG. 5.

In another implementation, the group common CG configuration contains UE-specific periods containing N consecutive UE-specific CG resources and each UE transmits within the UE-specific resource allocated within the UE specific period. In another implementation, each CG period is associated with one cycle of telegram from EtherCAT and each of the UE-specific CG resources is associated with a datagram associated with a slave node. In another implementation, a group common CG resource may contain N UE-specific resources containing each UE's repetition of a TB for a blind retransmission attempt for the TB.

In one embodiment, a UE-specific time offset is relatively calculated from the beginning of a CG period and provides information regarding transmissions in the corresponding UE-specific CG resource. In another implementation, a UE-specific time offset is relatively calculated from the beginning of the frame boundary or slot boundary. With the implementation shown in FIG. 5, a UE may transmit in one of the N UE specific CG resources depending on the traffic arrival time.

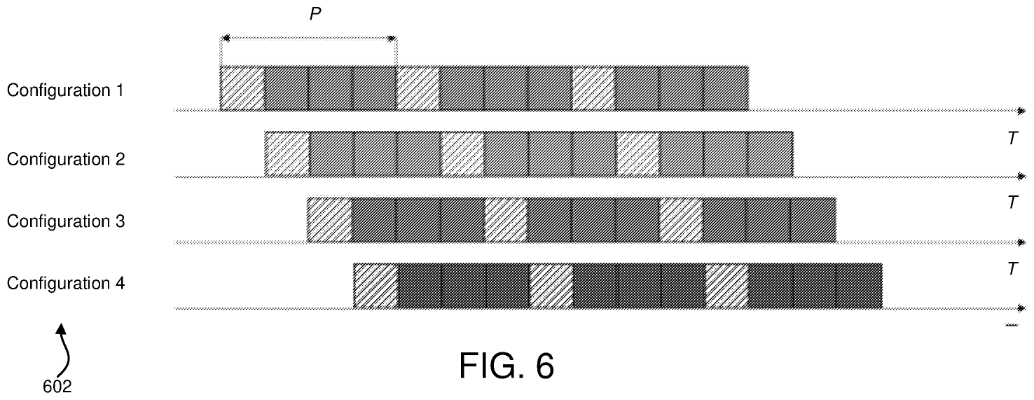

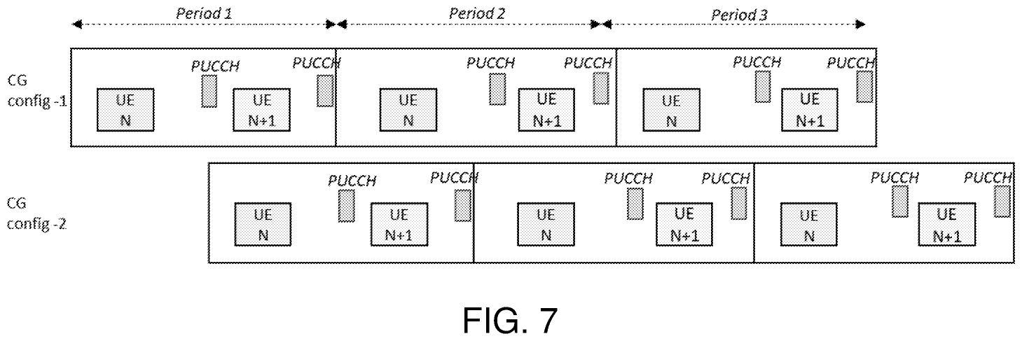

In one embodiment, a group common CG configuration includes one or more L2 destination IDs/L2 prose IDs for an applicable group common CG configuration. In one implementation, each Tx UE could use the group common CG configuration for transmission of a TB to the configured destination IDs. In another implementation, if an L2 destination ID/L2 prose ID is not provided, then a Tx UE uses each UE-specific CG resource for transmission of a TB to any destination ID. In another implementation, as shown in FIG. 6, one or more CG configurations 602 associated with a destination ID where each of the CG configurations is associated with a UE belonging to a group destination. In another implementation as shown in FIG. 7, different CG configurations are provided for a destination, but the selection of a CG configuration depends on the traffic arrival.

In one embodiment, each UE is not allowed to transmit in a CG resource that is not allocated to itself. In one embodiment, if a packet arrives later than its UE-N allocated CG resource, then all UEs in the group may skip the period and begin the transmission in the next period, if the packet delay budget (“PDB”) allows.

In one implementation, if the PDB does not allow transmission in the next period, the UE may transmit a scheduling request (“SR”) to a gNB to request a dynamic grant. In such an embodiment, a separate SR may be configured for this purpose and a gNB could proactively provide a dynamic grant to one or more UEs in the group with one or more time offsets according to their burst arrival time.

In one embodiment, at the end of N UE-specific CG resources, a PSFCH resource follows where N=1, 2, 3, and so on, and at the end of N UE-specific CG resources a PUCCH resource follows where N=1, 2, 3, and so on, as shown in FIG. 4 and FIG. 5.

In such an embodiment, UEs are configured with two RNTI's, where one is a group common specific configured scheduling (“CS-RNTI”), which is to be used for the activation and deactivation of the group common CG configuration and the other RNTI is a UE-specific (unicast) CS-RNTI for handling feedback, retransmissions, and/or the like.

At the beginning of each period, in one embodiment, each UE may transmit a new TB in its own CG resource and retransmissions are handled dynamically and separately for each UE using a unicast DCI transmission with a unicast CS-RNTI that is assigned to each UE where one or more retransmissions could be performed before the N+1 UE-specific starting time offset. In each UE-specific resource, in one embodiment, a Tx UE could either transmit a unicast packet to UE N+1 or transmit a groupcast packet to all UEs in a group.

In one embodiment, each UE could be configured with a UE-specific spatial relation in terms of transmission and reception of quasi co-located (“QCL”) type D or transmission and reception beams/panels that could be used by each UE for its own transmission and/or reception.

In one embodiment, a group common DCI may be used for activating and/or deactivating the type-2 group common configured grant. In one embodiment, a new group common CS-RNTI may be defined for this purpose and is configured for this UE group.

In one implementation, a group common DCI may be used for activating and/or deactivating one or more type-2 configured grants associated with a destination. One of the DCI fields, in one embodiment, indicates one or more CG configuration indices that needs to be activated and/or deactivated. In one embodiment, one of the DCI fields indicates the destination ID and one or more CG configurations that are associated with the destination are activated and/or deactivated.

In one embodiment, a UE validates, for scheduling activation of a CG type-2 group common physical downlink control channel (“PDCCH”), (1) the cyclic redundancy check (“CRC”) of a corresponding group common DCI format that is scrambled with a group common CS-RNTI provided by group common cs-RNTI and/or, if present, (2) that a new data indicator field in the group common DCI format for the enabled transport block is set to ‘0’, (3) the downlink feed information (“DFI”) flag field in the DCI format is set to ‘0’, a (4) HARQ process number in the DCI field is set to zero, and/or (5) a redundancy version field in the DCI is set to zero. In one embodiment, when a UE is provided with more than one configuration of type 2 configured grant, then the HARQ process number field in the corresponding SCI indicates the same value as provided by configuredGrantConfgIndex. If validation is not achieved, in one embodiment, the UE discards all the information in the DCI format.

In one embodiment, a UE validates, for scheduling deactivation of a CG type-2 group common PDCCH, (1) the CRC of a corresponding group common DCI format is scrambled with a group common CS-RNTI provided by group common cs-RNTI, (2) a HARQ process number in the DCI field is set to zero, (3) redundancy version field in the DCI is set to zero, (4) modulation and coding scheme (“MCS”) field in the DCI is set to zero, and/or (5) frequency domain resource allocation (“FDRA”) field in the DCI is set to zero for subcarrier spacing (“SCS”) of 15 KHz and to one otherwise. When a UE is provided with more than one configuration of type 2 configured grant, then the HARQ process number field in the corresponding SCI indicates the same value as provided by configuredGrantConfigIndex.

In one embodiment, if the PDCCH content indicates a configured grant type 2 activation or deactivation, a UE-specific configured grant confirmation MAC CE is triggered, e.g., according to the definition in 3GPP TS 38.321 Table 6.2.1.2, by each UE in the group.

In one embodiment, a multiple entry UE-specific configured grant confirmation MAC CE is identified by a MAC sub-header with an extended logical channel ID (“eLCID”), e.g., as specified in 3GPP TS 38.321 Table 6.2.1-2b, by each UE in the group depending on the reception of a PDCCH activation or deactivation with ConfiguredGrantConfigIndexMAC i has been received.

In another implementation, only one Tx UE, which could be configured by the gNB, transmits the MAC CE confirmation configured grant type 2 activation or deactivation on behalf of all group member UEs.

In some embodiments, the group common CG configuration could also be applicable for type 1 CG configuration where the CG configuration signaled from radio resource control (“RRC”) contains one or more destination IDs, which would eventually restrict the usage of type 1 CG configuration to one or more destination IDs.

In some embodiments, the group common type-2 CG configuration could be implemented as a Mode 1 group common CG configuration provided by RRC signaling containing one or more destination IDs, where a new group common DCI format could be used for activation and/or deactivation of the type 2 CG configuration.

In some embodiments, the group common type-2 CG configuration could be implemented as a combined DL semi-persistent scheduling (“SPS”) and UL CG resources for a group of UEs containing an associated destination, where DL symbols/slots could be used for the transmission of DL SPS and UL symbols/slots. In one embodiment, HARQ-ACK/NACK feedback for UL CG may be sent using a unicast DCI using a toggled or non-toggled new data indicator (“NDI”) or a group common DCI with a DFI containing HARQ-ACK/NACK feedback for all UL HARQ processes associated with the group common CG. In some embodiments, a gNB, after receiving a NACK in the PUCCH resource, may send an activation DCI containing a new UE specific offset and period by reconfiguring the group common type 2 CG configuration.

In one embodiment, the network, e.g., gNB, allocates ‘N_{Total}’ periodic resources to the group of UEs that are the intended recipients of the EtherCat Telegram where N_{Total} is the total number of recipients. In one embodiment, if the network is further enabled to read the header inspection of the telegram message, it might only allocate periodic NT_{ransmitterUEs} resources. The periodicity, or the time gap between each resource, in one embodiment, is only to the tune of time a receiver ‘m’ takes to receive (e.g., read), operate on (e.g., write), and finally transmit the message towards UE ‘m+1’. In such an embodiment, any periodic resources are available for use by any of the group members. However, the order in which the UEs respond (e.g., read-write-transmit) to the EtherCat message is performed according to the EtherCat protocol, and this information is provided to the RAN scheduler as a burst arrival time, along with the identifier, to schedule each node in the EtherCAT. In one embodiment, the RAN may utilize this assistance information further to understand the order of scheduling the slave nodes. In one embodiment, the last UE using the last resource for a particular EtherCat transmits the final message back to the gNB. In one embodiment, ‘N_{Total}’ periodic resources may contain resources for both Uu and Pc5.

In some embodiments, a Tx UE provides resources to the Rx UE's transmission and the Tx UE may reserve one or more resources for the Rx UE(s). In one implementation, one bit in the SCI is used to indicate that the reserved resource could be used by the Rx UE's transmission. In another implementation, a Rx UE uses remaining reserved resources after successfully decoding the Tx UE's SL TB. In another implementation, a combination of the above methods may be implemented. In another implementation, a new second SCI could be used that contains reserved and/or scheduled resources for the Rx UE's transmission. In one embodiment, a Rx UE utilizes the resources signaled in the second SCI as well as the remaining reserved resources signaled in the first SCI after successfully decoding a SL TB from a Tx UE.

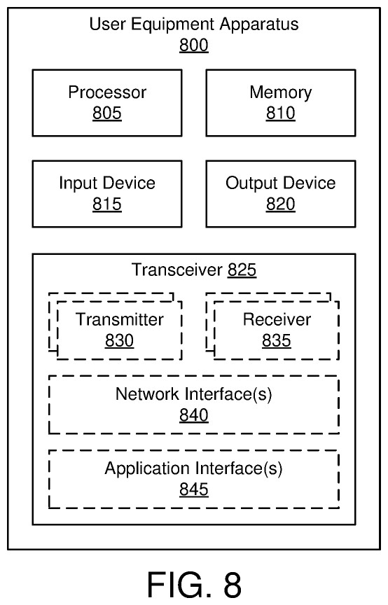

FIG. 8 depicts a user equipment apparatus 800 that may be used for group common configured grant resource configuration, according to embodiments of the disclosure. In various embodiments, the user equipment apparatus 800 is used to implement one or more of the solutions described above. The user equipment apparatus 800 may be one embodiment of the remote unit 105 and/or the UE 205, described above. Furthermore, the user equipment apparatus 800 may include a processor 805, a memory 810, an input device 815, an output device 820, and a transceiver 825.

In some embodiments, the input device 815 and the output device 820 are combined into a single device, such as a touchscreen. In certain embodiments, the user equipment apparatus 800 may not include any input device 815 and/or output device 820. In various embodiments, the user equipment apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. In some embodiments, the transceiver 825 communicates with one or more cells (or wireless coverage areas) supported by one or more base units 121. In various embodiments, the transceiver 825 is operable on unlicensed spectrum. Moreover, the transceiver 825 may include multiple UE panels supporting one or more beams. Additionally, the transceiver 825 may support at least one network interface 840 and/or application interface 845. The application interface(s) 845 may support one or more APIs. The network interface(s) 840 may support 3GPP reference points, such as Uu, N1, PC5, etc. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the processor 805 controls the user equipment apparatus 800 to implement the above-described UE behaviors. In certain embodiments, the processor 805 may include an application processor (also known as “main processor”) which manages application-domain and operating system (“OS”) functions and a baseband processor (also known as “baseband radio processor”) which manages radio functions.

The memory 810, in one embodiment, is a computer readable storage medium. In some embodiments, the memory 810 includes volatile computer storage media. For example, the memory 810 may include a RAM, including dynamic RAM (“DRAM”), synchronous dynamic RAM (“SDRAM”), and/or static RAM (“SRAM”). In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to group common configured grant resource configuration. For example, the memory 810 may store various parameters, panel/beam configurations, resource assignments, policies, and the like as described above. In certain embodiments, the memory 810 also stores program code and related data, such as an operating system or other controller algorithms operating on the apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 820 may include a wearable display separate from, but communicatively coupled to, the rest of the user equipment apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all, or portions of the output device 820 may be integrated with the input device 815. For example, the input device 815 and output device 820 may form a touchscreen or similar touch-sensitive display. In other embodiments, the output device 820 may be located near the input device 815.

The transceiver 825 communicates with one or more network functions of a mobile communication network via one or more access networks. The transceiver 825 operates under the control of the processor 805 to transmit messages, data, and other signals and to receive messages, data, and other signals. For example, the processor 805 may selectively activate the transceiver 825 (or portions thereof) at times to send and receive messages.

The transceiver 825 includes at least transmitter 830 and at least one receiver 835. One or more transmitters 830 may be used to provide UL communication signals to a base unit 121, such as the UL transmissions described herein. Similarly, one or more receivers 835 may be used to receive DL communication signals from the base unit 121, as described herein. Although only one transmitter 830 and one receiver 835 are illustrated, the user equipment apparatus 800 may have any suitable number of transmitters 830 and receivers 835. Further, the transmitter(s) 830 and the receiver(s) 835 may be any suitable type of transmitters and receivers. In one embodiment, the transceiver 825 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 825, transmitters 830, and receivers 835 may be implemented as physically separate components that access a shared hardware resource and/or software resource, such as for example, the network interface 840.

In various embodiments, one or more transmitters 830 and/or one or more receivers 835 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 830 and/or one or more receivers 835 may be implemented and/or integrated into a multi-chip module. In some embodiments, other components such as the network interface 840 or other hardware components/circuits may be integrated with any number of transmitters 830 and/or receivers 835 into a single chip. In such embodiment, the transmitters 830 and receivers 835 may be logically configured as a transceiver 825 that uses one more common control signals or as modular transmitters 830 and receivers 835 implemented in the same hardware chip or in a multi-chip module.

In one embodiment, the transceiver (825) receives, from a network, a group common configured grant (“CG”) configuration for a group common CG resource, the group common CG configuration for a plurality of UE devices in a group. In one embodiment, the processor (805) determines, from the group common CG configuration, a UE-specific CG resource configuration for the group common CG resource, the UE-specific CG resource configuration comprising one or more group common CG parameters and one or more UE-specific parameters for the group common CG resource. In one embodiment, the transceiver (825) transmits and receives data using the group common CG resource according to the group common CG parameters and the UE-specific CG parameters.

In one embodiment, the processor (805) configures, based on the group common CG configuration, the UE with two radio network temporary identifiers (“RNTIs”), one RNTI being a group common specific configured scheduling RNTI (“CS-RNTI”) and the other RNTI being a UE-specific unicast CS-RNTI.

In one embodiment, the processor (805) configures, based on the group common CG configuration, a new group common configured scheduling radio network temporary identifier (“CS-RNTI”) associated with a group common downlink control information (“DCI”) format for activation and deactivation of the group common CG configuration.

In one embodiment, the processor (805) configures, based on the group common CG configuration, a UE-specific radio network temporary identifier (“RNTI”) for one or more of feedback handling and retransmissions.

In one embodiment, the processor (805) associates the group common CG configuration with one or more L2 destination identifiers.

In one embodiment, the processor (805) configures, based on the group common CG configuration, the UE with UE-specific spatial relationships in terms of one or more of transmission and reception quasi-colocation type D and transmission and reception beams/panels used for transmission and reception.

In one embodiment, a CG period for the group common CG resource is associated with one cycle of telegram from EtherCAT and the UE-specific CG resource configuration is for a UE-specific CG resource associated with a datagram for a slave node.

In one embodiment, the transceiver (825) transmits a new transport block (“TB”) at a beginning of each CG period.

In one embodiment, the transceiver (825) skips transmitting in the UE-specific CG resource associated with the UE-specific CG resource configuration for a CG resource in response to a packet arriving late.

In one embodiment, the transceiver (825) dynamically retransmits a transport block (“TB”) in the UE-specific CG resource associated with the UE-specific CG resource configuration using a unicast downlink control information (“DCI”) transmission with a unicast configured scheduling radio network temporary identifier (“CS-RNTI”) assigned the UE, the retransmission performed separately from retransmissions for one or more other UE devices in the group and before a subsequent UE-specific starting time offset.

In one embodiment, the UE is designated as a transmitting UE for the group that is configured, by the network, to transmit medium access control control element (“MAC CE”) confirmation of activation and deactivation of the group common CG resource.

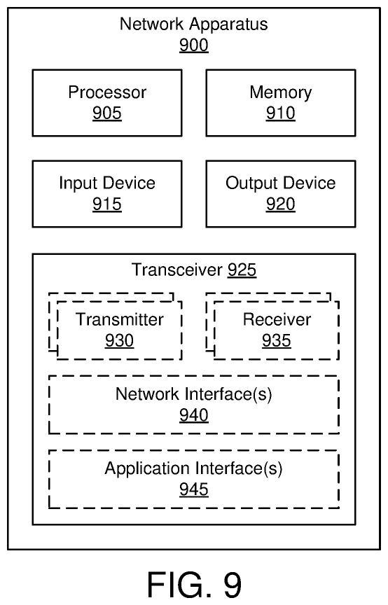

FIG. 9 depicts a network apparatus 900 that may be used for group common configured grant resource configuration, according to embodiments of the disclosure. In one embodiment, network apparatus 900 may be one implementation of a RAN node, such as the base unit 121 and/or the RAN node 210, as described above. Furthermore, the base network apparatus 900 may include a processor 905, a memory 910, an input device 915, an output device 920, and a transceiver 925.

In some embodiments, the input device 915 and the output device 920 are combined into a single device, such as a touchscreen. In certain embodiments, the network apparatus 900 may not include any input device 915 and/or output device 920. In various embodiments, the network apparatus 900 may include one or more of: the processor 905, the memory 910, and the transceiver 925, and may not include the input device 915 and/or the output device 920.

As depicted, the transceiver 925 includes at least one transmitter 930 and at least one receiver 935. Here, the transceiver 925 communicates with one or more remote units 175. Additionally, the transceiver 925 may support at least one network interface 940 and/or application interface 945. The application interface(s) 945 may support one or more APIs. The network interface(s) 940 may support 3GPP reference points, such as Uu, N1, N2 and N3. Other network interfaces 940 may be supported, as understood by one of ordinary skill in the art.

The processor 905, in one embodiment, may include any known controller capable of executing computer-readable instructions and/or capable of performing logical operations. For example, the processor 905 may be a microcontroller, a microprocessor, a CPU, a GPU, an auxiliary processing unit, a FPGA, or similar programmable controller. In some embodiments, the processor 905 executes instructions stored in the memory 910 to perform the methods and routines described herein. The processor 905 is communicatively coupled to the memory 910, the input device 915, the output device 920, and the transceiver 925.

In various embodiments, the network apparatus 900 is a RAN node (e.g., gNB) that communicates with one or more UEs, as described herein. In such embodiments, the processor 905 controls the network apparatus 900 to perform the above-described RAN behaviors. When operating as a RAN node, the processor 905 may include an application processor (also known as “main processor”) which manages application-domain and operating system (“OS”) functions and a baseband processor (also known as “baseband radio processor”) which manages radio functions.

The memory 910, in one embodiment, is a computer readable storage medium. In some embodiments, the memory 910 includes volatile computer storage media. For example, the memory 910 may include a RAM, including dynamic RAM (“DRAM”), synchronous dynamic RAM (“SDRAM”), and/or static RAM (“SRAM”). In some embodiments, the memory 910 includes non-volatile computer storage media. For example, the memory 910 may include a hard disk drive, a flash memory, or any other suitable non-volatile computer storage device. In some embodiments, the memory 910 includes both volatile and non-volatile computer storage media.

In some embodiments, the memory 910 stores data related to group common configured grant resource configuration. For example, the memory 910 may store parameters, configurations, resource assignments, policies, and the like, as described above. In certain embodiments, the memory 910 also stores program code and related data, such as an operating system or other controller algorithms operating on the apparatus 900.

The input device 915, in one embodiment, may include any known computer input device including a touch panel, a button, a keyboard, a stylus, a microphone, or the like. In some embodiments, the input device 915 may be integrated with the output device 920, for example, as a touchscreen or similar touch-sensitive display. In some embodiments, the input device 915 includes a touchscreen such that text may be input using a virtual keyboard displayed on the touchscreen and/or by handwriting on the touchscreen. In some embodiments, the input device 915 includes two or more different devices, such as a keyboard and a touch panel.

The output device 920, in one embodiment, is designed to output visual, audible, and/or haptic signals. In some embodiments, the output device 920 includes an electronically controllable display or display device capable of outputting visual data to a user. For example, the output device 920 may include, but is not limited to, an LCD display, an LED display, an OLED display, a projector, or similar display device capable of outputting images, text, or the like to a user. As another, non-limiting, example, the output device 920 may include a wearable display separate from, but communicatively coupled to, the rest of the network apparatus 900, such as a smart watch, smart glasses, a heads-up display, or the like. Further, the output device 920 may be a component of a smart phone, a personal digital assistant, a television, a table computer, a notebook (laptop) computer, a personal computer, a vehicle dashboard, or the like.

In certain embodiments, the output device 920 includes one or more speakers for producing sound. For example, the output device 920 may produce an audible alert or notification (e.g., a beep or chime). In some embodiments, the output device 920 includes one or more haptic devices for producing vibrations, motion, or other haptic feedback. In some embodiments, all, or portions of the output device 920 may be integrated with the input device 915. For example, the input device 915 and output device 920 may form a touchscreen or similar touch-sensitive display. In other embodiments, the output device 920 may be located near the input device 915.

The transceiver 925 includes at least transmitter 930 and at least one receiver 935. One or more transmitters 930 may be used to communicate with the UE, as described herein. Similarly, one or more receivers 935 may be used to communicate with network functions in the PLMN and/or RAN, as described herein. Although only one transmitter 930 and one receiver 935 are illustrated, the network apparatus 900 may have any suitable number of transmitters 930 and receivers 935. Further, the transmitter(s) 930 and the receiver(s) 935 may be any suitable type of transmitters and receivers.

In one embodiment, the processor (905) determines one or more group common configured grant (“CG”) parameters and one or more user equipment (“UE”)-specific parameters for a group common CG resource. In one embodiment, the transceiver (925) transmits, to a plurality of UE devices, a group common CG configuration for the group common CG resource, the group common CG configuration comprising the group common CG parameters and the UE-specific parameters. In one embodiment, the transceiver (925) transmits and receives data to/from the plurality of UE devices using the group common CG resource according to the group common CG parameters and the UE-specific CG parameters.

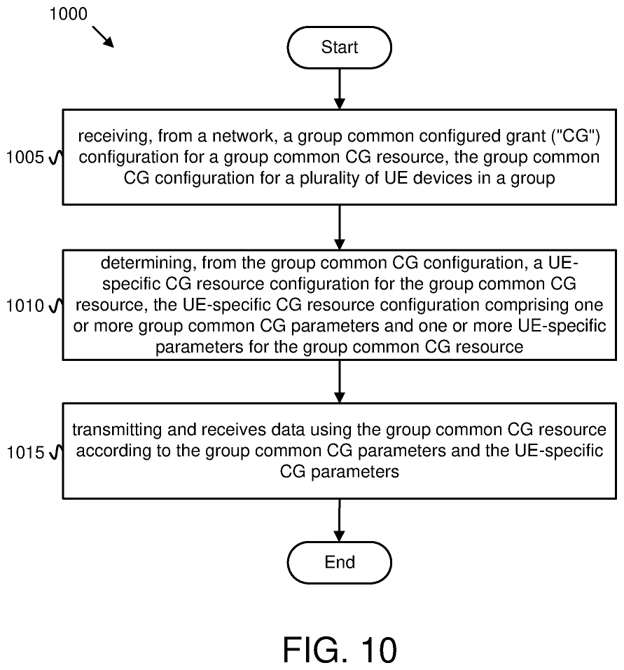

FIG. 10 depicts one embodiment of a method 1000 for group common configured grant resource configuration, according to embodiments of the disclosure. In various embodiments, the method 1000 is performed by a user equipment device in a mobile communication network, such as the remote unit 105, the UE 205, and/or the user equipment apparatus 800. In some embodiments, the method 1000 is performed by a processor, such as a microcontroller, a microprocessor, a CPU, a GPU, an auxiliary processing unit, a FPGA, or the like.

In one embodiment, the method 1000 begins and receives 1005, from a network, a group common configured grant (“CG”) configuration for a group common CG resource, the group common CG configuration for a plurality of UE devices in a group. In one embodiment, the method 1000 determines 1010, from the group common CG configuration, a UE-specific CG resource configuration for the group common CG resource, the UE-specific CG resource configuration comprising one or more group common CG parameters and one or more UE-specific parameters for the group common CG resource. In one embodiment, the method 1000 transmits 1015 and receives data using the group common CG resource according to the group common CG parameters and the UE-specific CG parameters. The method 1000 ends.

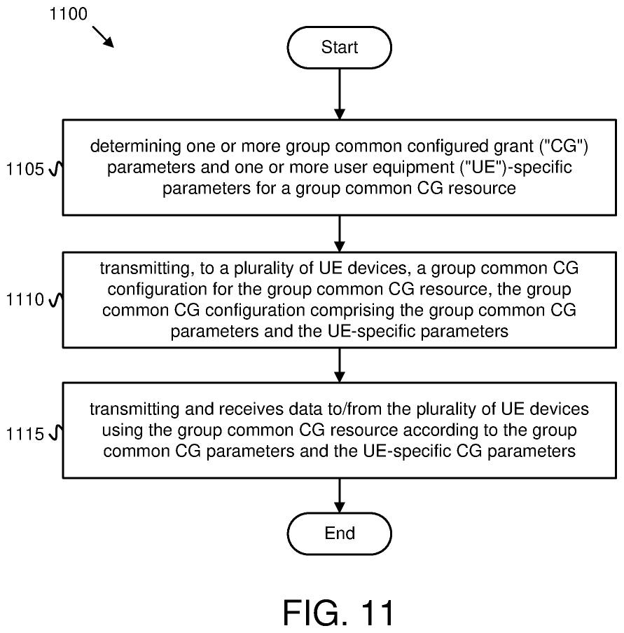

FIG. 11 depicts one embodiment of a method 1100 for group common configured grant resource configuration, according to embodiments of the disclosure. In various embodiments, the method 1100 is performed by a network function and/or a network equipment apparatus 900, such as base unit 121. In some embodiments, the method 1100 is performed by a processor, such as a microcontroller, a microprocessor, a CPU, a GPU, an auxiliary processing unit, a FPGA, or the like.

In one embodiment, the method 1100 begins and determines 1105 one or more group common configured grant (“CG”) parameters and one or more user equipment (“UE”)-specific parameters for a group common CG resource. In one embodiment, the method 1100 transmits 1110, to a plurality of UE devices, a group common CG configuration for the group common CG resource, the group common CG configuration comprising the group common CG parameters and the UE-specific parameters. In one embodiment, the method 1100 transmits 1115 and receives data to/from the plurality of UE devices using the group common CG resource according to the group common CG parameters and the UE-specific CG parameters. The method 1100 ends.

Disclosed herein is a first apparatus for group common configured grant resource configuration, according to embodiments of the disclosure. The first apparatus may be implemented by a user equipment device in a mobile communication network, such as the remote unit 105, the UE 205, and/or the user equipment apparatus 800, described above. In one embodiment, the first apparatus is implemented by a processor, such as a microcontroller, a microprocessor, a CPU, a GPU, an auxiliary processing unit, a FPGA, or the like.

In one embodiment, the first apparatus includes a transceiver that receives, from a network, a group common configured grant (“CG”) configuration for a group common CG resource, the group common CG configuration for a plurality of UE devices in a group. In one embodiment, the first apparatus includes a processor that determines, from the group common CG configuration, a UE-specific CG resource configuration for the group common CG resource, the UE-specific CG resource configuration comprising one or more group common CG parameters and one or more UE-specific parameters for the group common CG resource. In one embodiment, the transceiver transmits and receives data using the group common CG resource according to the group common CG parameters and the UE-specific CG parameters.

In one embodiment, the processor configures, based on the group common CG configuration, the UE with two radio network temporary identifiers (“RNTIs”), one RNTI being a group common specific configured scheduling RNTI (“CS-RNTI”) and the other RNTI being a UE-specific unicast CS-RNTI.

In one embodiment, the processor configures, based on the group common CG configuration, a new group common configured scheduling radio network temporary identifier (“CS-RNTI”) associated with a group common downlink control information (“DCI”) format for activation and deactivation of the group common CG configuration.

In one embodiment, the processor configures, based on the group common CG configuration, a UE-specific radio network temporary identifier (“RNTI”) for one or more of feedback handling and retransmissions.

In one embodiment, the processor associates the group common CG configuration with one or more L2 destination identifiers.

In one embodiment, the processor configures, based on the group common CG configuration, the UE with UE-specific spatial relationships in terms of one or more of transmission and reception quasi-colocation type D and transmission and reception beams/panels used for transmission and reception.

In one embodiment, a CG period for the group common CG resource is associated with one cycle of telegram from EtherCAT and the UE-specific CG resource configuration is for a UE-specific CG resource associated with a datagram for a slave node.

In one embodiment, the transceiver transmits a new transport block (“TB”) at a beginning of each CG period.

In one embodiment, the transceiver skips transmitting in the UE-specific CG resource associated with the UE-specific CG resource configuration for a CG resource in response to a packet arriving late.

In one embodiment, the transceiver dynamically retransmits a transport block (“TB”) in the UE-specific CG resource associated with the UE-specific CG resource configuration using a unicast downlink control information (“DCI”) transmission with a unicast configured scheduling radio network temporary identifier (“CS-RNTI”) assigned the UE, the retransmission performed separately from retransmissions for one or more other UE devices in the group and before a subsequent UE-specific starting time offset.

In one embodiment, the UE is designated as a transmitting UE for the group that is configured, by the network, to transmit medium access control control element (“MAC CE”) confirmation of activation and deactivation of the group common CG resource.

Disclosed herein is a first method for group common configured grant resource configuration, according to embodiments of the disclosure. The first method is performed by a user equipment device in a mobile communication network, such as the remote unit 105, the UE 205, and/or the user equipment apparatus 800, described above, and/or a network equipment apparatus 1200, such as base unit 121. In some embodiments, the first method is performed by a processor, such as a microcontroller, a microprocessor, a CPU, a GPU, an auxiliary processing unit, a FPGA, or the like.

In one embodiment, the first method receives, from a network, a group common configured grant (“CG”) configuration for a group common CG resource, the group common CG configuration for a plurality of UE devices in a group. In one embodiment, the first method determines, from the group common CG configuration, a UE-specific CG resource configuration for the group common CG resource, the UE-specific CG resource configuration comprising one or more group common CG parameters and one or more UE-specific parameters for the group common CG resource. In one embodiment, the first method transmits and receives data using the group common CG resource according to the group common CG parameters and the UE-specific CG parameters.

In one embodiment, the first method configures, based on the group common CG configuration, the UE with two radio network temporary identifiers (“RNTIs”), one RNTI being a group common specific configured scheduling RNTI (“CS-RNTI”) and the other RNTI being a UE-specific unicast CS-RNTI.

In one embodiment, the first method configures, based on the group common CG configuration, a new group common configured scheduling radio network temporary identifier (“CS-RNTI”) associated with a group common downlink control information (“DCI”) format for activation and deactivation of the group common CG configuration.

In one embodiment, the first method configures, based on the group common CG configuration, a UE-specific radio network temporary identifier (“RNTI”) for one or more of feedback handling and retransmissions.

In one embodiment, the first method associates the group common CG configuration with one or more L2 destination identifiers.

In one embodiment, the first method configures, based on the group common CG configuration, the UE with UE-specific spatial relationships in terms of one or more of transmission and reception quasi-colocation type D and transmission and reception beams/panels used for transmission and reception.

In one embodiment, a CG period for the group common CG resource is associated with one cycle of telegram from EtherCAT and the UE-specific CG resource configuration is for a UE-specific CG resource associated with a datagram for a slave node.

In one embodiment, the first method transmits a new transport block (“TB”) at a beginning of each CG period.

In one embodiment, the first method skips transmitting in the UE-specific CG resource associated with the UE-specific CG resource configuration for a CG resource in response to a packet arriving late.

In one embodiment, the first method dynamically retransmits a transport block (“TB”) in the UE-specific CG resource associated with the UE-specific CG resource configuration using a unicast downlink control information (“DCI”) transmission with a unicast configured scheduling radio network temporary identifier (“CS-RNTI”) assigned the UE, the retransmission performed separately from retransmissions for one or more other UE devices in the group and before a subsequent UE-specific starting time offset.

In one embodiment, the UE is designated as a transmitting UE for the group that is configured, by the network, to transmit medium access control control element (“MAC CE”) confirmation of activation and deactivation of the group common CG resource.

Disclosed herein is a second apparatus for group common configured grant resource configuration, according to embodiments of the disclosure. The second apparatus may be implemented by a network function and/or a network equipment apparatus 1200, such as a base unit 121. In one embodiment, the second apparatus is implemented by a processor, such as a microcontroller, a microprocessor, a CPU, a GPU, an auxiliary processing unit, a FPGA, or the like.

In one embodiment, the second apparatus includes a processor that determines one or more group common configured grant (“CG”) parameters and one or more user equipment (“UE”)-specific parameters for a group common CG resource. In one embodiment, the second apparatus includes a transceiver that transmits, to a plurality of UE devices, a group common CG configuration for the group common CG resource, the group common CG configuration comprising the group common CG parameters and the UE-specific parameters. In one embodiment, the transceiver transmits and receives data to/from the plurality of UE devices using the group common CG resource according to the group common CG parameters and the UE-specific CG parameters.

Disclosed herein is a second method for group common configured grant resource configuration, according to embodiments of the disclosure. The second method is performed by a network function and/or a network equipment apparatus 1200, such as a base unit 121. In some embodiments, the second method is performed by a processor, such as a microcontroller, a microprocessor, a CPU, a GPU, an auxiliary processing unit, a FPGA, or the like.

In one embodiment, the second method determines one or more group common configured grant (“CG”) parameters and one or more user equipment (“UE”)-specific parameters for a group common CG resource. In one embodiment, the second method transmits, to a plurality of UE devices, a group common CG configuration for the group common CG resource, the group common CG configuration comprising the group common CG parameters and the UE-specific parameters. In one embodiment, the second method transmits and receives data to/from the plurality of UE devices using the group common CG resource according to the group common CG parameters and the UE-specific CG parameters.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (“UE”) for wireless communication, comprising:
at least one memory; and
at least one processor coupled with the at least one memory and configured to cause the UE to:
receives a group common configured grant (“CG”) configuration for a group common CG resource, the group common CG configuration for a plurality of UE devices in a group;
determine, based on the group common CG configuration, a UE-specific CG resource configuration for the group common CG resource, the UE-specific CG resource configuration comprising one or more group common CG parameters and one or more UE-specific parameters for the group common CG resource; and
perform data communications using the group common CG resource according to the group common CG parameters and the UE-specific CG parameters.

2. The UE of claim 1, wherein the at least one processor is configured to cause the UE to, based on the group common CG configuration, configure the UE with at least two radio network temporary identifiers (“RNTIs”), a first RNTI being a group common specific configured scheduling RNTI (“CS-RNTI”) and a second RNTI being a UE-specific unicast CS-RNTI.

3. The UE of claim 1, wherein the at least one processor is configured to cause the UE to, based on the group common CG configuration, configure a new group common configured scheduling radio network temporary identifier (“CS-RNTI”) associated with a group common downlink control information (“DCI”) format for activation or deactivation of the group common CG configuration.

4. The UE of claim 1, wherein the at least one processor is configured to cause the UE to, based on the group common CG configuration, configure a UE-specific radio network temporary identifier (“RNTI”) for feedback handling, retransmissions, or a combination thereof.

5. The UE of claim 1, wherein the at least one processor is configured to cause the UE to associate the group common CG configuration with one or more L2 destination identifiers.

6. The UE of claim 1, wherein the at least one processor is configured to cause the UE to, based on the group common CG configuration, configure the UE with UE-specific spatial relationships in connection with quasi-colocation type D and beams or panels used for transmission or reception.

7. The UE of claim 1, wherein a CG period for the group common CG resource is associated with a cycle of telegram from EtherCAT and the UE-specific CG resource configuration is for a UE-specific CG resource associated with a datagram for a slave node.

8. The UE of claim 1, wherein the at least one processor is configured to cause the UE to transmit a new transport block (“TB”) at a beginning of each CG period.

9. The UE of claim 1, wherein the at least one processor is configured to cause the UE to skip transmitting in the UE-specific CG resource associated with the UE-specific CG resource configuration for a CG resource in response to a packet arriving later than an expected arrival time.

10. The UE of claim 1, wherein the at least one processor is configured to cause the UE to dynamically retransmit a transport block (“TB”) in the UE-specific CG resource associated with the UE-specific CG resource configuration using a unicast downlink control information (“DCI”) transmission with a unicast configured scheduling radio network temporary identifier (“CS-RNTI”), the dynamic retransmission performed separately from retransmissions for at least one other UE device in the group and prior to a subsequent UE-specific starting time offset.

11. The UE of claim 1, wherein the UE is designated as a transmitting UE for the group that is configured to transmit medium access control (“MAC”) control element (“CE”) confirmation of activation or deactivation of the group common CG resource.

12. A method performed by a user equipment (“UE”), the method comprising:
receiving a group common configured grant (“CG”) configuration for a group common CG resource, the group common CG configuration for a plurality of UE devices in a group;
determining, based on the group common CG configuration, a UE-specific CG resource configuration for the group common CG resource, the UE-specific CG resource configuration comprising one or more group common CG parameters and one or more UE-specific parameters for the group common CG resource; and
performing data communications using the group common CG resource according to the group common CG parameters and the UE-specific CG parameters.

13. The method of claim 12, further comprising configuring, based on the group common CG configuration, the UE with at least two radio network temporary identifiers (“RNTIs”), a first RNTI being a group common specific configured scheduling RNTI (“CS-RNTI”) and a second RNTI being a UE-specific unicast CS-RNTI.

14. The method of claim 12, further comprising configuring, based on the group common CG configuration, a new group common configured scheduling radio network temporary identifier (“CS-RNTI”) associated with a group common downlink control information (“DCI”) format for activation or deactivation of the group common CG configuration.

15. A network equipment for wireless communication, comprising:
at least one memory; and
at least one processor coupled with the at least one memory and configured to cause the base station to:
determine one or more group common configured grant (“CG”) parameters and one or more user equipment (“UE”)-specific parameters for a group common CG resource;
transmits a group common CG configuration for the group common CG resource, the group common CG configuration comprising the group common CG parameters and the UE-specific parameters; and
perform data communications using the group common CG resource according to the group common CG parameters and the UE-specific CG parameters.

16. A processor for wireless communication, comprising:
at least one controller coupled with at least one memory and configured to cause the processor to:
receive a group common configured grant (“CG”) configuration for a group common CG resource, the group common CG configuration for a plurality of UE devices in a group;
determine, based on the group common CG configuration, a user equipment (“UE”)-specific CG resource configuration for the group common CG resource, the UE-specific CG resource configuration comprising one or more group common CG parameters and one or more UE-specific parameters for the group common CG resource; and
perform data communications using the group common CG resource according to the group common CG parameters and the UE-specific CG parameters.

17. The processor of claim 16, wherein the at least one controller is configured to cause the processor to, based on the group common CG configuration, configure a UE with at least two radio network temporary identifiers (“RNTIs”), a first RNTI being a group common specific configured scheduling RNTI (“CS-RNTI”) and a second RNTI being a UE-specific unicast CS-RNTI.

18. The processor of claim 16, wherein the at least one controller is configured to cause the processor to, based on the group common CG configuration, configure a new group common configured scheduling radio network temporary identifier (“CS-RNTI”) associated with a group common downlink control information (“DCI”) format for activation or deactivation of the group common CG configuration.

19. The processor of claim 16, wherein the at least one processor is configured to cause the UE to, based on the group common CG configuration, configure a UE-specific radio network temporary identifier (“RNTI”) for feedback handling, retransmissions, or a combination thereof.

20. The processor of claim 16, wherein the at least one processor is configured to cause the UE to associate the group common CG configuration with one or more L2 destination identifiers.
